(19) United States
(12) Patent Application Publication
(10) Pub. No.: US 2023/0092198 A1
(43) Pub. Date: Mar. 23, 2023

(54) SYSTEMS AND METHODS OF REAL-TIME DETECTION OF AND GEOMETRY GENERATION FOR PHYSICAL GROUND PLANES

(71) Applicant: AEye, Inc., Dublin, CA (US)

(72) Inventor: Abhijit V. Thatte, Dublin, CA (US)

(73) Assignee: AEye, Inc., Dublin, CA (US)

(21) Appl. No.: 17/483,548

(22) Filed: Sep. 23, 2021

(51) Int. Cl. G01S 17/89; G01S 17/931; B60W 40/02

(52) U.S. Cl. CPC G01S 17/89; G01S 17/931; B60W 40/02; B60W 2420/52; B60W 2556/45

(57) ABSTRACT

Example implementations can include a method of real-time detection of and geometry generation for physical ground planes, the method including generating a point cloud based on one or more detected points, the detected points being reflected from one or more projected points of focused light projected onto an environment, slicing, in accordance with at least one coordinate space threshold, one or more threshold points from the point cloud to generate a first sliced point cloud excluding the threshold points, slicing, in accordance with at least one residual threshold, one or more residual points from the first sliced point cloud to generate a second sliced point cloud excluding the residual points, generating a ground plane aligned with one or more points of the second point cloud in the coordinate space, and calculating a geometric characteristic of the second ground plane.

### TECHNICAL FIELD

The present disclosure relates generally to sensor devices, and more particularly to real-time detection of and geometry generation for physical ground planes.

### BACKGROUND

Physical environments, including built environments for transportation, are becoming increasingly crowded, and complex. In addition to throughways for motor vehicles, built environments increasingly include throughways for pedestrians, human-powered vehicles, and mass transit vehicles. In addition, demands on motor vehicles to successfully navigate environments autonomously and independently are increasing rapidly, to reduce cognitive load on a vehicle driver or pilot. However, conventional vehicle systems cannot efficiently and effectively model and react to the environment surrounding the vehicle within computational and power resource requirements associated with vehicle systems. Thus, an effective and reliable autonomous vehicle navigation system is desired.

### SUMMARY

Present implementations are directed at least to modeling a portion of an environment surrounding a vehicle system. The modeling can include generating a model of at least a portion of the environment and adapting the model substantially in real-time based on one or more sensor inputs to the vehicle system of the environment. The portion of the environment can include a ground plane representing a road surface or ground surface. Thus, present implementations can advantageously generate and regenerate, in substantially real time, a model of the ground plane on which the vehicle or vehicle system, for example, is located or traversing, for example. A vehicle in accordance with present implementations can thus advantageously operate within an environment and modify its operation within the environment, based at least partially on a model indicating a substantially real-time structure of the ground plane of the environment.

Present implementations can achieve substantially real-time modeling of a ground plane in accordance with at least computational and power resource requirements of various sensor systems to detect aspects of the environment. The sensor systems can include time-of-flight sensors, laser-based sensors, coherent light sensor systems, focused light sensor systems, Light Detection and Ranging (LIDAR) systems, or Laser Detection And Ranging (LADAR) systems, for example. Substantially real-time can include a process occurring at least as quickly as a sensor system input is capable of generating a complete sensor input. As one example, present implementations can generate ground plane models in rapid succession, with each ground plane model generated or capable of being generated based on a partial input from a sensor system. Present implementations can advantageously achieve substantially real-time modeling of at least a ground plane at a rate faster than a rate of capture of one or more environmental sensors providing input to the model generator, and can generate a rapidly-updating environmental map at a rate exceeding sensor constraint limitations. In addition, present implementations can apply one or more artificial intelligence techniques to detect and remove objects in the environment distinct from the ground plane, in order to generate a model corresponding accurately to the ground plane and minimizing distortion from many types of environmental objects, including but not limited to people, vehicles, and fixed roadway structures. Thus, a technological solution for real-time detection of and geometry generation for physical ground planes is provided.

Example implementations can include a method of real-time detection of and geometry generation for physical ground planes, the method including generating a point cloud based on one or more detected points, the detected points being reflected from one or more projected points of focused light projected onto an environment, slicing, in accordance with at least one coordinate space threshold, one or more threshold points from the point cloud to generate a first sliced point cloud excluding the threshold points, slicing, in accordance with at least one residual threshold, one or more residual points from the first sliced point cloud to generate a second sliced point cloud excluding the residual points, and generating a ground plane aligned with one or more points of the second point cloud in the coordinate space.

Example implementations can also include a method of further generating the residual threshold based on a geometry of the first sliced point cloud.

Example implementations can also include a method of further generating an intermediate ground plane aligned in the coordinate space with one or more points of the first sliced point cloud.

Example implementations can also include a method where the point cloud corresponds to a portion of a field of view of the environment.

Example implementations can also include a method of further capturing a frame including the point cloud, the frame corresponding to the field of view.

Example implementations can also include a method of further generating the ground plane based on a partial frame corresponding to the portion of the field of view.

Example implementations can also include a method of further detecting one or more of the projected points reflected from the environment, where each of the detected points is associated with one or more corresponding spatial identifiers in the coordinate space.

Example implementations can also include a method where each of the projected points is associated with at least one of the corresponding spatial identifiers.

Example implementations can also include a method of further calculating a geometric characteristic of the second ground plane, and transmitting a vehicle operation instruction based on the geometric characteristic.

Example implementations can include a system with a point cloud generator configured to generate a point cloud based on one or more detected points, the detected points being reflected from one or more projected points of focused light projected onto an environment, a point slicer engine configured to slice, in accordance with at least one coordinate space threshold, one or more threshold points from the point cloud to generate a first sliced point cloud excluding the threshold points, and slice, in accordance with at least one residual threshold, one or more residual points from the first sliced point cloud to generate a second sliced point cloud excluding the residual points, and a plane generator configured to generate a ground plane aligned with one or more points of the second point cloud in the coordinate space.

Example implementations can also include a system where the point slicer engine can generate the residual threshold based on a geometry of the first sliced point cloud.

Example implementations can also include a system where the plane generator can generate an intermediate ground plane aligned in the coordinate space with one or more points of the first sliced point cloud.

Example implementations can also include a system where the point cloud corresponds to a portion of a field of view of the environment.

Example implementations can also include a system where the point cloud generator can capture a frame including the point cloud, based on the frame corresponding to the field of view.

Example implementations can also include a system where the plane generator can generate the ground plane based on a partial frame corresponding to the portion of the field of view.

Example implementations can also include a system with a point cloud generator configured to detect one or more of the projected points reflected from the environment, where each of the detected points is associated with one or more corresponding spatial identifiers in the coordinate space.

Example implementations can also include a system where each of the projected points is associated with at least one of the corresponding spatial identifiers.

Example implementations can also include a system with a vehicle operation interface configured to transmit a vehicle operation instruction based on a geometric characteristic of the second ground plane, where the plane generator is further configured to calculate the geometric characteristic.

Example implementations can include a computer readable medium including one or more instructions stored thereon and executable by a processor to generate a point cloud based on one or more detected points, the detected points being reflected from one or more projected points of focused light projected onto an environment, slice, in accordance with at least one coordinate space threshold, one or more threshold points from the point cloud to generate a first sliced point cloud excluding the threshold points, generate a residual threshold based on a geometry of the first sliced point cloud, slice, in accordance with at least one residual threshold, one or more residual points from the first sliced point cloud to generate a second sliced point cloud excluding the residual points, and generate a ground plane aligned with one or more points of the second point cloud in the coordinate space.

Example implementations can also include a computer readable medium including one or more instructions executable by a processor to detect one or more of the projected points reflected from the environment, where each of the detected points is associated with one or more corresponding spatial identifiers in the coordinate space.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1A illustrates an example system in accordance with present implementations.

FIG. 1B illustrates an example system in an operating state further to the example system of FIG. 1A.

FIG. 2A illustrates an example operating environment associated with a system in accordance with present implementations.

FIG. 2B illustrates a first example operating state of a system in the operating environment, further to the example operating environment of FIG. 2A.

FIG. 2C illustrates a second example operating state of a system in the operating environment, further to the first state of FIG. 2B.

FIG. 3A illustrates a third example operating state of a system in the operating environment, in accordance with present implementations.

FIG. 3B illustrates a fourth example operating state of a system in the operating environment, further to the third state of FIG. 3A.

FIG. 3C illustrates a fifth example operating state of a system in the operating environment, further to the fourth state of FIG. 3B.

FIG. 4 illustrates an example structure of a system memory of the system, in accordance with present implementations.

FIG. 5 illustrates an example method of real-time detection of and geometry generation for physical ground planes, in accordance with present implementations.

FIG. 6 illustrates an example method of real-time detection of and geometry generation for physical ground planes, further to the example method of FIG. 5.

FIG. 7 illustrates an example method of real-time detection of and geometry generation for physical ground planes, further to the example method of FIG. 6.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

Present implementations can include one or more sensor input and output systems, and one or more processing and memory systems located with, affixed to, integrated with, or associated with for example, a vehicle. The vehicle can include an autonomous vehicle, a partially autonomous vehicle, a vehicle in which one or more components or systems thereof can operate at least partially autonomously, or any combination thereof, for example. The sensor systems can include LADAR or LIDAR systems as discussed above, and can scan across an environment to generate a time-of-flight grid image of an environment or a portion of an environment. Present implementations can include one or more processing systems to generate and modify an environmental model based on at least a portion of the grid image received from the sensor systems. The processing systems can generate a ground plane from portions of the grid image as the grid image is received, and can repeatedly or continuously modify the environmental model as further portions of the image are received, to advantageously provide environmental feedback to a vehicle system or vehicle, for example, outside the constraints of a sensor capture speed or rate, for example, associated with a sensor system.

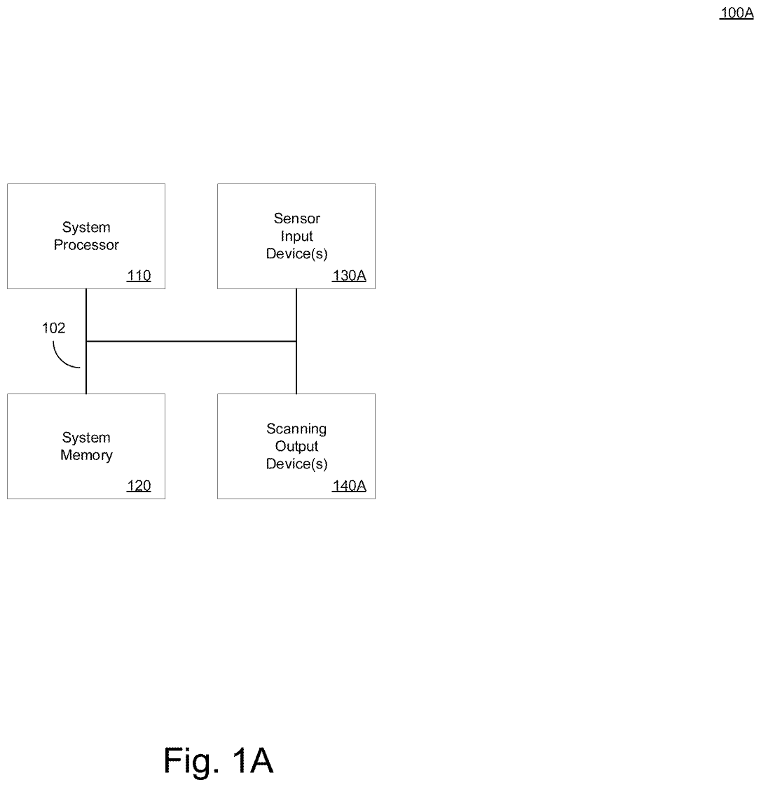

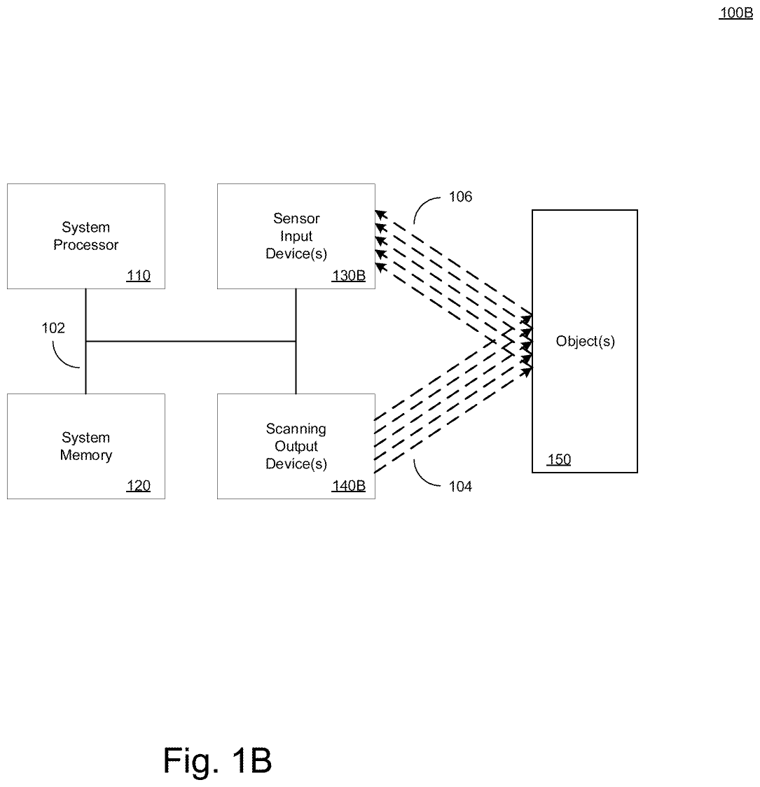

FIG. 1A illustrates an example system in accordance with present implementations. As illustrated by way of example in FIG. 1A, an example system 100 can include at least one system processor 110, at least one system memory 120, at least one sensor input device 130A, at least one scanning output device 140A, and at least one communication bus 102. The system 100 can be at least partially housed in, integrated with, attached to, affixed to, or engaged with, for example, an external object. The external object can include a moveable object. The moveable object can include an automobile, aircraft, watercraft, or spacecraft, for example. The system processor 110 can execute one or more instructions associated with the system 100. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. The one or more instructions can include at least one of firmware, software, hardware, operating systems, embedded operating systems, and the like. The system processor 110 or the system 100 generally can include at least one communication bus controller to effect communication between the system processor 110 and the other elements of the system 100.

The system memory 120 can store data associated with the system 100. The system memory 120 can include one or more hardware memory devices to store binary data, digital data, analog data, or the like. The system memory 120 can include one or more electrical components, electronic components, programmable electronic components, reprogrammable electronic components, integrated circuits, semiconductor devices, flip flops, arithmetic units, or the like. The system memory 120 can include at least one of a non-volatile memory device, a solid-state memory device, a flash memory device, and a NAND memory device. The system memory 120 can include one or more addressable memory regions disposed on one or more physical memory arrays. A physical memory array can include a NAND gate array disposed on, for example, at least one of a particular semiconductor device, integrated circuit device, and printed circuit board device.

The sensor input device 130A can receive time-of flight feedback received from an environment. The environment can include an environmental surface, or environmental object, for example. The sensor input device 130A can include one or more light capture elements operable to receive and detect light reflected from an environment and projected by the scanning output device 140A. The light capture elements can be arranged in an array, a grid or gridlike structure, and can detect one or more values corresponding to one or more coordinates associated with an environment. The light capture elements can include but are not limited to, photosensitive electrical, electronic, or semiconductor devices. As one example, an environment can be associated with an XYZ coordinate space having an x-axis, a y-axis, and a z-axis, with each axis being orthogonal to all others in the coordinate space.

The sensor input device 130A can detect at least one returned light beam or the like reflected from the environment and originating from the scanning output device 140A, and can generate at least one coordinate based on a time difference between a time of transmission of the beam or pulse of light from the scanning output device 140A and a time of receipt of the beam or pulse of light at the sensor input device 130A. The sensor input device 130A can receive multiple beams or pulses of light simultaneously or concurrently, and can associate each beam or pulse with at least one coordinate of a coordinate system independently of receiving a returned light beam. It is to be understood that the image capture elements are not limited to a grid or gridlike arrangement.

The scanning output device 140A can transmit or project, for example, one or more light beams or pulses onto an environment. The scanning output device 140A can include one or more light projection elements and can be arranged in a configuration corresponding to an arrangement of image capture elements of the sensor input device 130A. Thus, the scanning output device can project one or more beams or pulses of light with respect to a coordinate system of the sensor input device 130A. As one example, the scanning output device 140A can project a plurality of light beams arranged linearly into an environment. Each of the plurality of light beams can be associated with a common coordinate in a first axis, and a distinct coordinate in a second axis. For example, the scanning output device 140A can project a line of light beams having a common Z-axis (e.g., elevation) coordinate of 0, and a distinct Y-axis (e.g., azimuth) coordinate from 0 to N. The scanning output device 140A can also move the orientation of a light projection array disposed therein and including one or more light projection elements. As one example, the scanning output device 140A can move the light projection array along the Z-axis in accordance with a predetermined step. Thus, the scanning output device 140A can traverse an Y Z plane based on a fixed orientation of a plurality of light projection elements along an Y-axis and a movement of the plurality of light projection elements along a Z-axis. It is to be understood that the light projection elements are not limited to a fixed orientation and are not limited to the axes or coordinate systems discussed herein by way of example. The light projection elements can include at least one of, but are not limited to, light-emitting diodes, laser diodes, chemical laser emitters, light focusing elements, lenses, collimators, and incandescent light bulbs.

The communication bus 102 can communicatively couple one or more of the system processor 110, the system memory 120, the sensor input device 120, and the scanning output device 140. The communication bus 102 can communicate one or more instructions, signals, conditions, states, or the like to or from one or more of the system processor 110, the system memory 120, the sensor input device 120, and the scanning output device 140. The communication bus 102 can include one or more digital, analog, or like communication channels, lines, traces, or the like. As one example, the communication bus 102 can include at least one serial or parallel communication line among multiple communication lines of a communication interface.

FIG. 1B illustrates an example system in an operating state further to the example system of FIG. 1A. As illustrated by way of example in FIG. 1B, an example system 100B in an operating state includes the system processor 110, the system memory 120, the sensor input device 130B in the operating state receiving reflected light 106 from an object 150, the scanning output device 140B in the operating state projecting light 104 onto the object 150, and the one communication bus 102.

The sensor input device 130B in the operating state can receive reflected light 106 from the object 150. The sensor input device 130B in the operating state can include an array of light capture elements oriented toward the environment to receive the reflected light 106. The sensor input device 130B can move across the environment along an axis for example, corresponding to an axis of movement of the scanning output device 140B. The sensor input device 130B can move across the environment at a speed or rate, for example, corresponding to speed or rate of movement of the scanning output device 140B.

The scanning output device 140B in the operating state can project light 104 can project light onto the object 150. The output device 140B in the operating state can include an array of light projection elements oriented toward the environment to project the light 104 onto the object 150. The scanning output device 140B can include an array of light projection elements oriented toward the environment to project the light 104 at an angle with respect to the object 150 to reflect, bounce, or the like, at least a portion of the light 104 from at least one surface of the object 150 to result in the reflected light 106.

The object 150 can include any portion of an environment proximate to the system 100B. The object can include a ground surface on which the system 100B or a vehicle including, integrated with, coupled with or associated with, for example, the system 100B. The object 150 can include multiple objects in the environment or part of the environment, either permanently or impermanently. As one example, the object 150 can include a ground surface, vehicles, pedestrians, bicycles, trains, or the like moving within, into or out of the environment, or features of the environment including the built environment or natural environment surrounding the vehicle. Objects can also include trees, traffic structures, roadways, railways, buildings, blockades, barriers, and benches, for example.

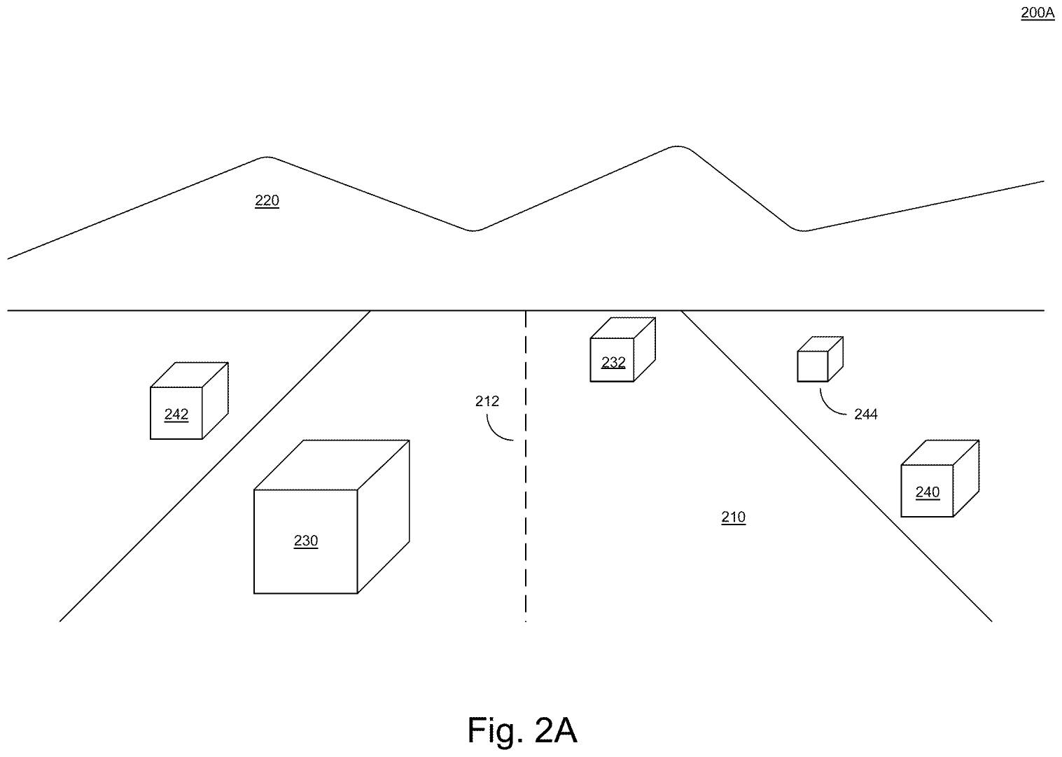

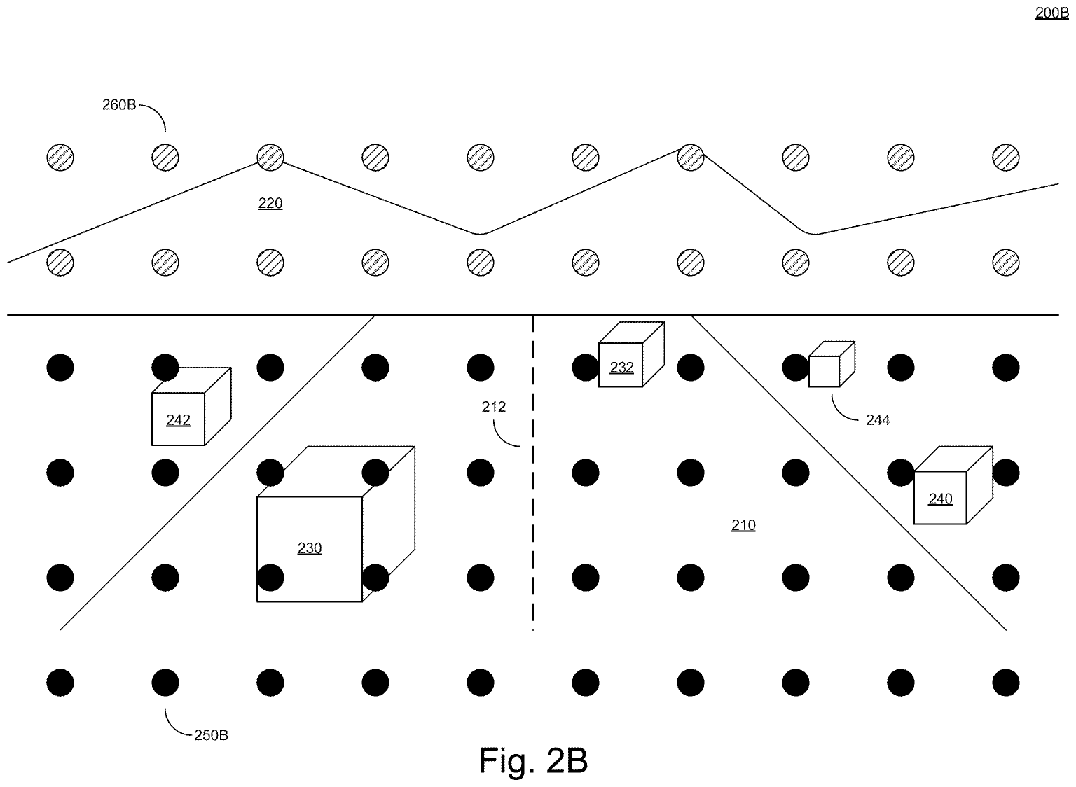

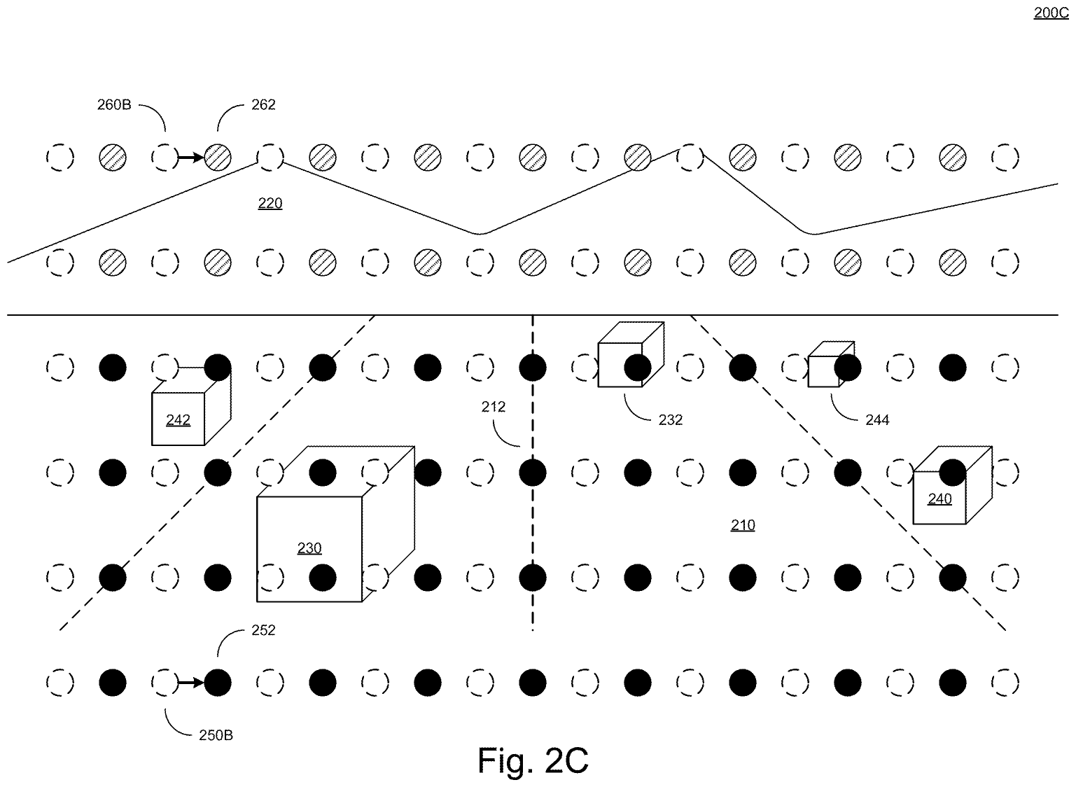

FIG. 2A illustrates an example operating environment associated with a system in accordance with present implementations. As illustrated by way of example in FIG. 2A, an example operating environment 200A includes a foreground region 210 and a background region 220. The background region 220 can include one or more objects beyond the sensor range of the system 100A or 100B. It is to be understood that the background region 220 is not limited to a distance or geospatial region corresponding to or limited by a horizon.

The foreground region 210 can include one or more of a marker 212, one or more proximate objects 230 and 232, and one or more peripheral objects 240, 242 and 244. The marker 212 can include one or more physical features of the foreground proximate to the vehicle or the system. The marker 212 can include a roadway marker, roadway feature, roadway hazard, ground marker, ground feature, or ground hazard, for example. The proximate objects 230 and 232 can include one or more objects proximate to the vehicle or the system 100A or 100B. The proximate objects 230 and 232 can be within a predetermined threshold distance of the vehicle or the system 100A or 100B with respect to one or more characteristics of a coordinate space. Characteristics of a coordinate space can include but are not limited to axes, arcs, curves, points, planes or surfaces within or associated with the coordinate space or the environment. The proximate objects 230 and 232 can include one or more roadway objects. The roadway objects can include, but are not limited to, vehicles traveling on the roadway in a direction of travel substantially matching or distinct from a direction of travel of the vehicle, pedestrians, roadway features, or other objects as discussed herein. The peripheral objects 240, 242 and 244 can include one or more objects proximate to the vehicle or the system 100A or 100B and outside an operating environment associated with the system 100A or 100B or a vehicle of the system 100A or 100B. The peripheral objects 240, 242 and 244 can include roadside objects. Roadside objects can include pedestrians, bicycles, trees, traffic structures, buildings, blockades, barriers, and benches, for example.

FIG. 2B illustrates a first example operating state of a system in the operating environment, further to the example operating environment of FIG. 2A. As illustrated by way of example in FIG. 2B, a first example operating state 200B of a system in accordance with present implementations can include the foreground region 210, the marker 212, the proximate objects 230 and 232, the peripheral objects 240, 242 and 244, the background region 220, a plurality of foreground points 250B and a plurality of background points 260B.

The foreground points 250B can include a plurality of light beams or pulses, for example, projected by the scanning output devices 140A-B onto one or more of the objects within the foreground region 210 and one or more surfaces of the foreground region 210 itself. The foreground points 250B can correspond to the light 104. The foreground points 250B can be reflected or returned, for example, at least partially from one or more objects of the foreground region 210 of the environment. The foreground points 250B can correspond to the reflected light 106, and can be reflected from various surfaces of the foreground objects and the foreground region 210. The scanning output devices 140A-B can project the foreground points 250B onto the foreground region 210 in accordance with a light projection array or the like as discussed above, having one or more light projection elements arranged along one or more axes. The scanning output devices 140A-B can project a single row of foreground points 250B arranged linearly along a single axis, or multiple rows of foreground points 250B arranged in multiple parallel lines along a single axis, as illustrated by way of example in FIG. 2B. The scanning output devices 140A-B can project the foreground points 250B across a second axis to generate a planar projection of points on the foreground region 210. It is to be understood that one or more foreground points may not be reflected back to the sensor inputs device 130A-B.

The background points 260B can include a plurality of light beams or pulses, for example, projected by the scanning output devices 140A-B onto one or more of the objects within the background region 220. The background points 260B can correspond to the light 104. The background points 260B can be lost or not returned from the background region 220 due to, for example, distance, interference, or dissipation of light. The scanning output devices 140A-B can project the background points 260B onto the background region 220 correspondingly to the projection of the foreground points 250B onto the foreground region 210, and can project onto the foreground region 210 and the background region 220 concurrently or simultaneously within a single sweep or frame encompassing at least a portion of both of the foreground region 210 and the background region 220.

FIG. 2C illustrates a second example operating state of a system in the operating environment, further to the first state of FIG. 2B. As illustrated by way of example in FIG. 2C, an example second example operating state 200B of a system in accordance with present implementations can include the foreground region 210, the marker 212, the proximate objects 230 and 232, the peripheral objects 240, 242 and 244, the background region 220, a plurality of shifted foreground points 252 and a plurality of shifted background points 262.

The shifted foreground points 252 can correspond in one or more of structure and operation to the foreground points 250B. The scanning output devices 140A-B can project the shifted foreground points 252 in a manner corresponding to projecting the foreground points 250B, and can project the shifted foreground points 252 by shifting an array of light projection elements to an angular position or a linear position, for example, different than a position corresponding to the foreground points 250B. As one example, the array can be oriented at 0° to project the foreground points 250B, and can be shifted to +0.05° to project the shifted foreground points 252. In some implementations, the scanning output devices 140A-B can project the foreground points 250B a predetermined amount of time after projecting the foreground points 252. The predetermined amount of time can correspond to one or more of an angular pitch or a linear displacement, for example, corresponding to a coordinate system associated with the environment. Thus, the shifted foreground points 250B can be associated with spatial information applicable to infer one or more coordinates or spatial characteristics associated with the environment independently of receiving returned light 106 at the sensor input device 130A-B. As one example, an angular step associated with a shift from the foreground points 250B to the shifted foreground points 252 can be associated with a predetermined distance, or pitch, within a coordinate space. The shifted background points 262 can correspond in one or more of structure and operation to the shifted foreground points 252 as discussed above.

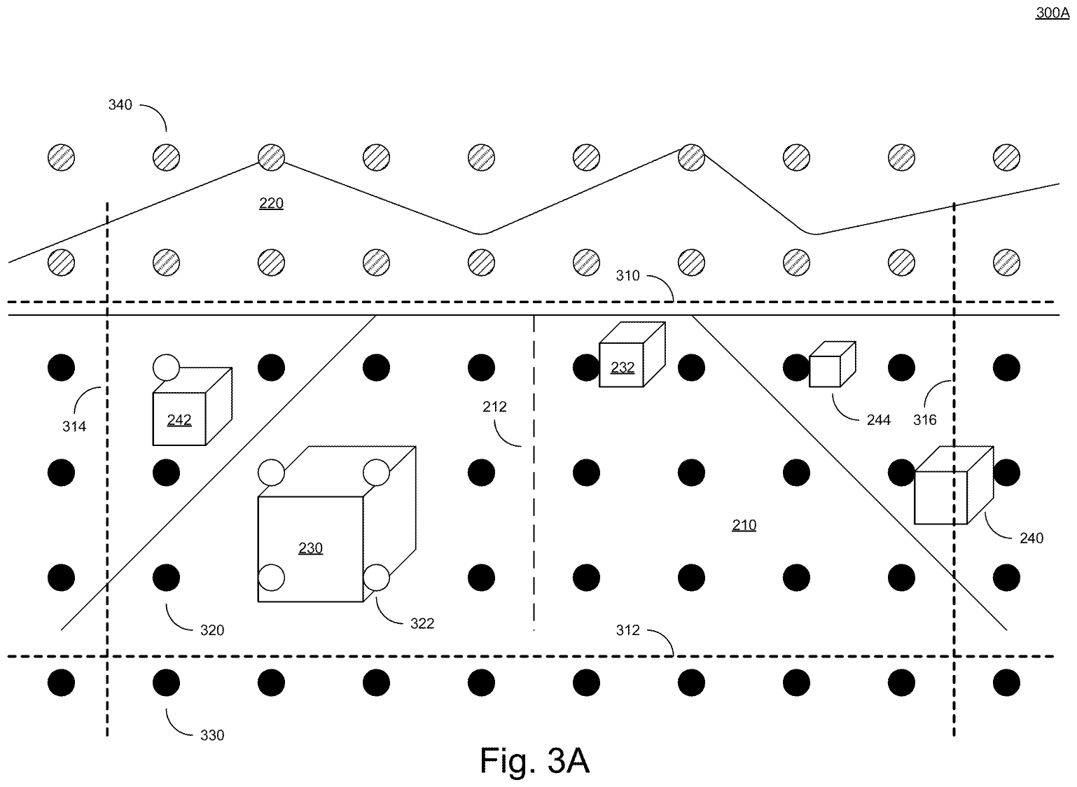

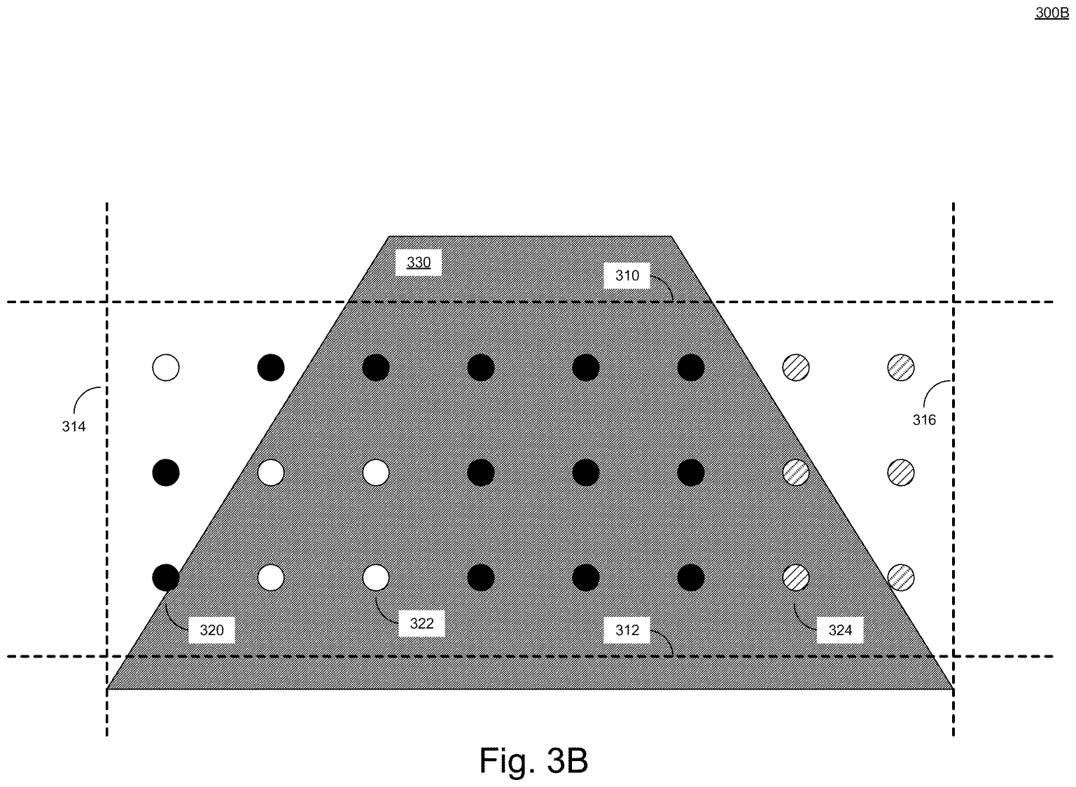

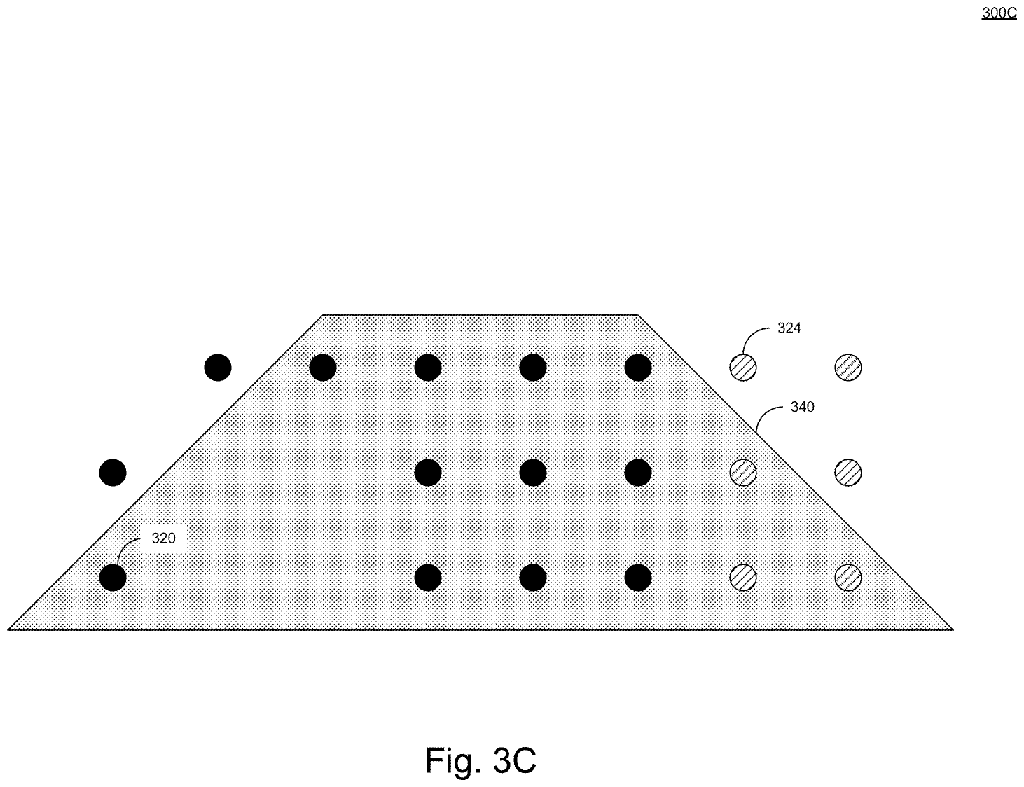

FIGS. 3A-C are directed to operating states corresponding at least partially in one or more of structure and operation to one or more of the environments and operating states of FIGS. 2A-C. The system 100A-B can generate the operating states 300A-C.

FIG. 3A illustrates a third example operating state of a system in the operating environment, in accordance with present implementations. As illustrated by way of example in FIG. 3A, an example operating state 300A can include the foreground region 210, the marker 212, the proximate objects 230 and 232, the peripheral objects 240, 242 and 244, the background region 220, frame thresholds 310, 312, 314 and 316, framed foreground points 320, object points 322, unframed foreground points 330, and unframed background points 340.

The frame thresholds 310, 312, 314 and 316 can restrict an environment field of view with respect to one or more components of the system 100A-B. The frame thresholds 310, 312, 314 and 316 can each correspond to a respective edge of a field of view corresponding to the environment. Each threshold can be defined with respect to a coordinate system associated with the environment, and can define a boundary for a sensor system or a processing system, for example. Thus, as one example, the frame thresholds 310, 312, 314 and 316 can respectively correspond to at least one coordinate in at least one axis associated with the environment. Thus, the frame threshold 310 can correspond to a top edge of a field of view, the frame threshold 312 can correspond to a bottom edge of a field of view, the frame threshold 314 can correspond to a left edge of a field of view, and the frame threshold 316 can correspond to a right edge of a field of view. Each edge can be associated with an absolute or relative distance within a coordinate space. As one example, the frame threshold 310 can be associated with 70.00° in a Z-axis direction, and the frame threshold 312 can be associated with 0.00° in the Z-axis direction. As another example, the frame threshold 314 can be associated with 0.00° in an Y-axis direction, and the frame threshold 316 can be associated with 190.00° in the Y -axis direction. It is to be understood that the example above are nonlimiting. The frame thresholds 310, 312, 314 and 316 can be associated with a predetermine portion of the environment associated with or potentially associated with a ground plane of the environment. As one example, the frame thresholds 310, 312, 314 and 316 can be predetermined to include a portion of the environment through which ground, pavement, or the like is visible or likely detectable by the sensor input device. Likely detectable can correspond to a portion of the environment having the ground pane during normal operation of a vehicle on which the system 100A-B is associated or integrated, for example. The frame thresholds 310, 312, 314 and 316 can be independently modifiable to include or exclude any portion of the environment based on an orientation or location, for example, of the system 100A-B or any component thereof with respect to a vehicle. For example, the frame thresholds 310 and 312 can be modified to be lower within a field of view of the environment where the system 100A-B is placed on the roof of a vehicle, and can be modified to be higher within a field of view of the environment where the system 100A-B is placed in the grille of a vehicle. Together, the frame thresholds 310, 312, 314 and 316 can enclose a frame window including all of the framed foreground points 320.

The framed foreground points 320 can include one or more projected points with coordinates disposed to satisfy one or more of the frame thresholds 310, 312, 314 and 316. The framed foreground points 320 can include points satisfying all of the frame thresholds 310, 312, 314 and 316 such that the frame thresholds form a frame including the framed foreground points 320 and excluding all other points associated with the environment. The system 100A-B can advantageously separately process the framed foreground points 320 from other points associated with the environment to generate a spatial model associated with the environment in substantially real-time and within the constraints of the hardware associated with the system 100A-B.

The object points 322 can include one or more projected points with coordinates disposed to satisfy one or more of the frame thresholds 310, 312, 314 and 316 and associated with one or more objects within the environment. The object points 322 can be associated with at least one coordinate having a difference with one or more of the framed foreground points 320. As one example, the object points 322 can be associated with one or more vehicles or stationary objects on or over a roadway, and can thus include a Y-axis coordinate above one or more of the framed foreground points 320 proximate thereto.

The unframed foreground points 330 can include one or more projected points with coordinates disposed to not satisfy one or more of the frame thresholds 310, 312, 314 and 316. The unframed foreground points 330 can include points satisfying none of the frame thresholds 310, 321, 314 and 316 such that the frame thresholds form a frame excluding the unframed foreground points 330. The system 100A-B can advantageously block or forgo, for example, processing the unframed foreground points 330 to generate a spatial model associated with the environment in substantially real-time and within the constraints of the hardware associated with the system 100A-B. As one example, the spatial model can include a ground plane estimation model excluding the unframed foreground points 330. The unframed background points 340 can correspond at least partially in one or more of structure and function to the unframed foreground points 330, and can be correspondingly excluded from the frame window to generate the spatial model in substantially real-time and reducing computational load of processing, for example, thousands of unframed foreground points 330 and unframed background points 340 irrelevant to determination of a ground plane. Generation of the ground plane real-time and correction of the ground plane in real-time are critical to the technological solution of at least partially autonomous vehicle navigation and movement.

FIG. 3B illustrates a fourth example operating state of a system in the operating environment, further to the third state of FIG. 3A. As illustrated by way of example in FIG. 3B, an example operating state 300B includes the frame thresholds 310, 312, 314 and 316, the framed foreground points 320, the object points 322, uncaptured points 324, and ground plane 330. The environment can be represented by one or more of the foreground points 320, the object points 322, and the uncaptured points 324 within the frame window, and the operating state can include only these points.

The uncaptured points 324 can include one or more points within the frame window that have not been captured at the time of generating the ground plane. The uncaptured points 324 can include one or more of the foreground points 320 or the object points 322, and can correspond to a subset of points not yet captured in the frame. Thus, the uncaptured points 324 can correspond to portions of a frame that have not yet been captured. The system 100A-B can thus advantageously generate the ground plane based on a partial frame, before the uncaptured points 324 are captured. For example, the system 100A-B can capture a frame in 100 ms, and the system can generate a ground plane within 25 ms. Thus, the system 100A-B can advantageously generate multiple ground planes in less time than a capture process of a frame, and can thus generate a ground plane at higher frequency than a physical constraint imposed by the capture rate of a sensor system.

The ground plane 330 can include a model based on the ground plane associated with the environment of 300A. The ground plane 330 can be based on one or more of the foreground points 320 and the object points 322. The ground plane 330 can be based on the foreground points 320, and can exclude the uncaptured points 324. As one example, the ground plane 330 can be based on an increasing number of foreground points 320 as those foreground points become captured. Thus, the system 100A-B can advantageously generate the ground plane 330 based on any number of foreground points 320 captured at any time during the capture of a frame in accordance with FIGS. 2A-C.

FIG. 3C illustrates a fifth example operating state of a system in the operating environment, further to the fourth state of FIG. 3B. As illustrated by way of example in FIG. 3C, an example operating state 300C can include the framed foreground points 320, the uncaptured points 324, and ground plane 340. The environment can be represented by one or more of the foreground points 320 and the uncaptured points 324 within the frame window, and the operating state can include only these points.

The ground plane 340 can include a model based on the ground plane associated with the environment of 300A. The ground plane 340 can be based on one or more of the foreground points 320, and can exclude the object points 322. The ground plane 340 can be based on the foreground points 320, and can exclude the uncaptured points 324. As one example, the ground plane 340 can be based on an increasing number of foreground points 320 as those foreground points become captured, while excluding the object points 322. The system 100A-B can generate the ground plane 340 to reduce or eliminate distortion from objects on the ground plane of the environment by identifying the object points 322 and excluding the object points 322 from input to generate the ground plane 340. Thus, the system 100A-B can advantageously generate the ground plane 340 based on any number of foreground points 320 captured at any time during the capture of a frame in accordance with FIGS. 2A-C. The system 100A-B can further advantageously generate the ground plane in less time than is required to generate a complete frame, corresponding to the generation of the ground plane 330.

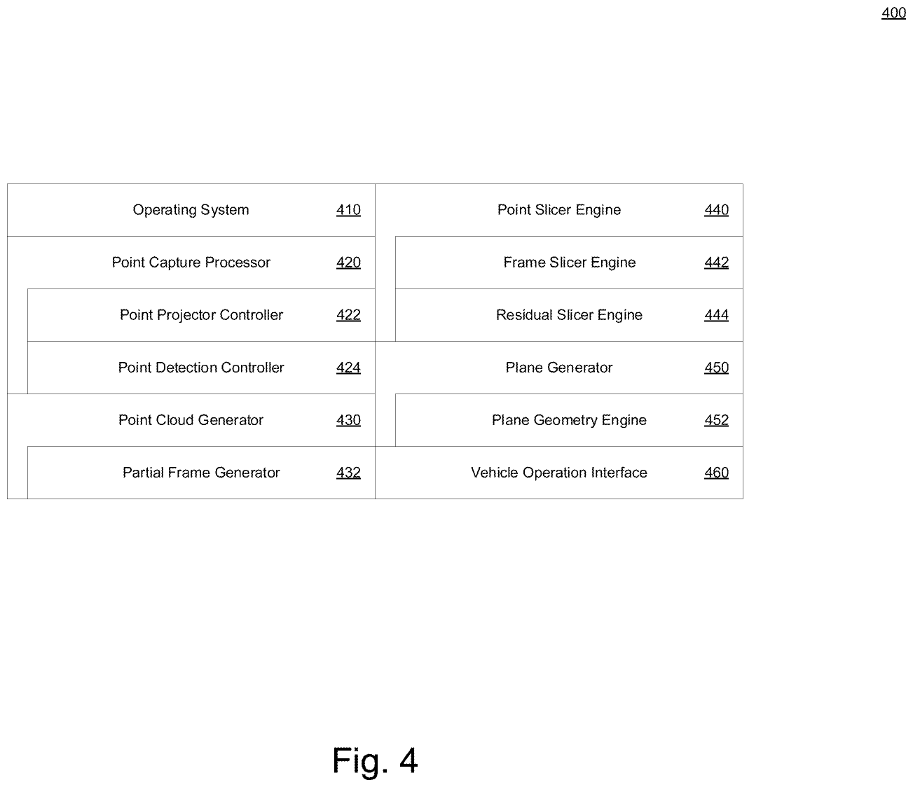

FIG. 4 illustrates an example structure of a system memory of the system, in accordance with present implementations. As illustrated by way of example in FIG. 4, an example system memory 400 can include an operating system 410, a point capture processor 420, a point cloud generator 430, a point slicer engine 440, a plane generator 450, and a vehicle operation interface 460. The system memory 400 can correspond in at least one of structure and operation to the system memory 120.

The operating system 410 can include hardware control instructions and program execution instructions. The operating system 410 can include a high level operating system, a server operating system, an embedded operating system, or a boot loader. The operating system 410 can include one or more instructions operable specifically with or only with the system processor 110.

The point capture processor 420 can include one or more instructions to generate one or more points associated with an environment and at least one coordinate space corresponding to the environment. The point capture processor 420 can include instructions to operate one or more LIDAR or LADAR image capture devices, for example, including one or more point projectors, time-of-flight sensors, and the like. The point capture processor 420 can include a point projector controller 422 and a point detection controller 424.

The projector controller 422 can include one or more instructions to operate the scanning output device 140A-B. The projector controller 422 can include instructions to activate and deactivate one or more light projection elements and one or more point arrays. The projector controller 422 can synchronize or coordinate, for example, movement of one or more point arrays across an environment in accordance with FIGS. 2A-C. The projector controller 422 can move the light projection elements or the point arrays including one or more of the light projection elements in accordance with one or more coordinate systems. As one example, the projector controller 422 can move the point array in accordance with an angular step in an angular coordinate system. The step can be a fixed step, or a variable step in accordance with a function. The fixed step can be, but is not limited to 0.05° in an angular coordinate system, and the variable step function can be a function including a step size dependent at least partially on an angular displacement for an origin in a coordinate space, for example.

The point detection controller 424 can include one or more instructions to operate the sensor input device 130A-B. The point detection controller 424 can include instructions to activate and deactivate one or more light capture elements and one or more point arrays. The point detection controller 424 can synchronize or coordinate, for example, movement of one or more point arrays across an environment in accordance with FIGS. 2A-C. The point detection controller 424 can move the light capture elements or the point arrays including one or more of the light capture elements in accordance with one or more coordinate systems, and in coordinate with movement of the light projection elements. As one example, the point detection controller 424 can move the point array in accordance with an angular step in an angular coordinate system corresponding to the step and coordinate system of the projector controller 422. The point detection controller 424 can also move the point array or the point capture elements at an offset in the coordinate system from the point array corresponding to the point projection elements. As one example, the point detection controller 424 can have a trailing offset in which the point detection controller 424 orients the point array or the point capture elements with respect to coordinates associated with a past orientation of the point array corresponding to the point projection elements.

The point cloud generator 430 can include one or more instructions to generate one or more collections of points corresponding to at least a portion of a physical environment. The collection of points can correspond to a point cloud. The point cloud generator 430 can generate a point cloud upon receiving one or more points from the point detection controller 424. The point cloud generator 430 can complete a point cloud when all points associated with a particular frame window are captured, and can cease to add points to a complete point cloud. The point cloud generator 430 can begin generating a point cloud in response to the start of a capture of a frame in accordance with FIGS. 2A-C. The point cloud generator 430 can include a partial frame generator 432. The partial frame generator 432 can include one or more instructions to generate a point cloud from a subset of points within a frame window. The partial frame generator 432 can repeatedly or continuously, for example, generate a point cloud based on continuing point cloud input. The partial frame generator 432 can thus continue adding points to a point cloud in real-time or substantially real-time as those points are detected by the point detection controller 424.

The point slicer engine 440 can include one or more instructions to modify a point cloud generated by the point cloud generator 430. The point slicer engine 440 can modify the point cloud by removing or adding points from the point cloud based on one or more criteria. The criteria can be intrinsic to individual points of the point cloud with respect to one or more points as discussed on FIGS. 2A-C and 3A-C. The criteria can be based on characteristics of the point cloud as a whole, based on aggregation of corresponding characteristics of one or more points of the point cloud. The criteria can include one or more thresholds, for example. It is to be understood that the point slicer engine 440 is not limited to the criteria discussed herein. The point slicer engine can include a frame slicer engine 442 and a residual slicer engine 444.

The frame slicer engine 442 can include one or more instructions to modify the point cloud based on one or more thresholds. The frame slicer engine 442 can include one or more predetermined frame thresholds corresponding to a coordinate system, physical environment, or spatial reference, for example. The frame slicer engine 442 can store and retrieve one or more of the frame thresholds 310, 312, 314 and 316 with respect to a coordinate system or an orientation of the sensor input device 130A-B and the scanning output device 140A-B, for example. Each of the frame thresholds 310, 312, 314 and 316 can be stored in a nonvolatile portion of the system memory 120 corresponding to the frame slicer engine 442. The frame slicer engine 442 can obtain a point cloud from the point cloud generator 430 and remove at least one point from the point cloud satisfying or not satisfying one or more of the frame thresholds. As one example, the frame slicer engine 442 can generate the point cloud of 300B based on receiving a partial or full frame of points from the point cloud generator 430.

The residual slicer engine 444 can include one or more instructions to modify the point cloud based on one or more residual thresholds. The residual thresholds can include one or more metrics associated with one or more points of the point cloud. As one example, a residual characteristic can include a mean height of a point above a plane defining the bottom of the coordinate space, and a residual threshold can include a function indicating a maximum distance above the plane, or a maximum deviation of a point from the mean above the plane. The residual slicer engine 444 can include one or more predetermined residual characteristics and thresholds corresponding to a coordinate system, physical environment, or spatial reference, for example. The residual slicer engine 444 can store and retrieve one or more of the residual characteristics and thresholds with respect to the point cloud, or any subset of points associated therewith, for example. Each of the residual characteristics and thresholds can be stored in a nonvolatile portion of the system memory 120 corresponding to the residual slicer engine 444. The residual slicer engine 444 can obtain a point cloud from the point cloud generator 430 and remove at least one point from the point cloud satisfying or not satisfying one or more of the residual thresholds. As one example, the frame slicer engine 442 can generate the point cloud of 300C based on receiving a partial or full frame of points from the point cloud generator 430.

The plane generator 450 can include one or more instructions to generate a plane corresponding to at least one feature in an environment. The feature in the environment can correspond to a physical surface within the environment, and can include a ground plane corresponding to a road surface or the like, for example. The plane generator can include at least one machine learning system operable to generate the ground plane in real-time or substantially real-time based on a complete or partial point cloud received from the point cloud generator 430.

The plane generator 450 can include a machine learning model structure operable to receive the point cloud as input and generate a plane corresponding to the surface of the ground plane based at least partially on at least one of the points of the point cloud. The plane generator 450 can generate planes corresponding to the ground plane, including ground planes 330 and 340, but is not limited thereto. The plane generator 450 can advantageously generate a ground plane automatically and in substantially real-time to achieve the technological solution of at least partially autonomous vehicle navigation and movement. The plane generator can include a plane geometry engine 452.

The plane geometry engine 452 can include one or more instructions to 452 indicating one or more features of the ground plane. The features of the ground plane can include geometry of the ground plane with respect to the coordinate system. The plane geometry engine 452 can generate, for example, one or more of a pitch, a roll, and a yaw of a plane generated by the plane generator 450. As one example, the plane geometry engine 452 can generate a first pitch, a first roll, and a first yaw corresponding to ground plane 330, and can generate a second pitch, a second roll, and a second yaw corresponding to ground plane 340.

The vehicle operation interface 460 can include one or more instructions to generate instructions to modify at least one operation of a vehicle associated with the system 100A-B. The vehicle operation interface 460 can include one or more alert systems to generate and transmit an alert in response to detection of a particular ground plane geometry. As one example, the vehicle operation interface 460 can generate a navigation instruction to a vehicle user interface system if the system 100A-B generates a ground plane that include a pitch, roll, or yaw beyond a vehicle operating threshold pitch, roll, or yaw, or other corresponding vehicle operation metric, for example. As another example, the vehicle operation interface 460 can generate a vehicle control instruction if the system 100A-B generates a ground plane that includes a pitch, roll, or yaw beyond a vehicle operating threshold pitch, roll, or yaw, or other corresponding vehicle operation metric, for example. The vehicle control instruction can include a brake instruction to stop the vehicle, for example.

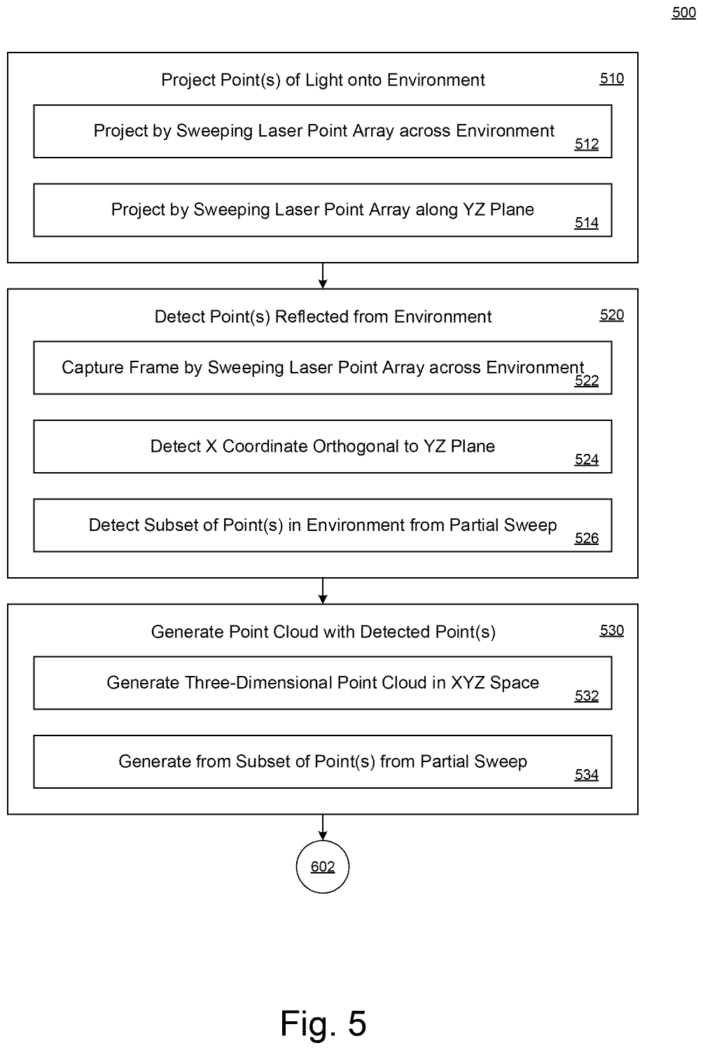

FIG. 5 illustrates an example method of real-time detection of and geometry generation for physical ground planes, in accordance with present implementations. The system 100 can perform method 500 according to present implementations. The method 500 can begin at 510.

At 510, the system projects one or more points of light onto an environment. 510 can include at least one of 512 and 514. At 512, the system can project points of light onto an environment by sweeping a laser point array across the environment. At 514, the system can project points of light onto an environment by sweeping a laser point array along a YZ plane of the environment. The method 500 then continues to 520.

At 520, the system can detect one or more points reflected from the environment. 520 can include at least one of 522, 524 and 526. At 522, the system can capture at least a portion of a frame associated with the environment by sweeping the laser point array across the environment. At 524, the system detects an X coordinate orthogonal to a YZ plane of the environment. At 526, the system detects a subset of the points detected from the environment and associated with a partial sweep. The partial sweep can correspond to a partial frame associated with a scanning window by a sensor system, and can correspond to the foreground points 320 and the object points 322, and can exclude the uncaptured foreground points 324. The method 500 then continues to 530.

At 530, the system can generate at least one point cloud based on one or more of the detected points. 530 can include at least one of 532 and 534. At 532, the system generates a three-dimensional (3D) point cloud in the XYZ coordinate space. At 534, the system generates the point cloud based at least partially on the subset of the points detected from the environment and associated with a partial sweep. The method 500 then continues to 602.

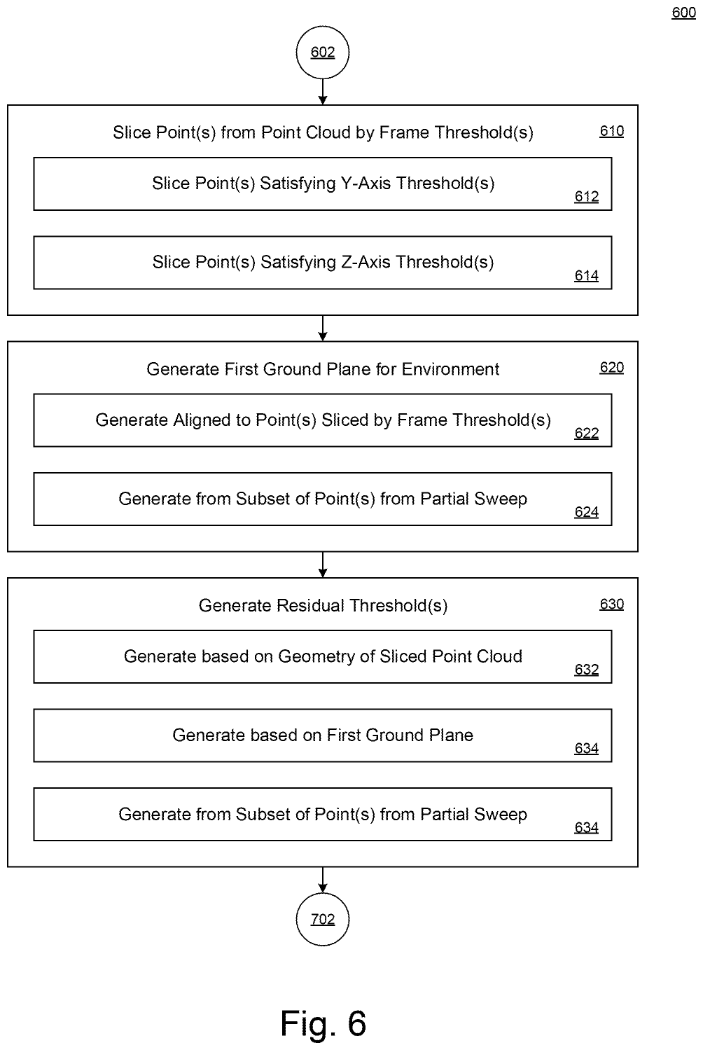

FIG. 6 illustrates an example method of real-time detection of and geometry generation for physical ground planes, further to the example method of FIG. 5. The system 100 can perform method 600 according to present implementations. The method 600 can begin at 602. The method 600 then continues to 610.

At 610, the system slices one or more points from the point cloud based on one or more frame thresholds. 610 can include at least one of 612 and 614. At 612, the system can slice points satisfying one or more Y-axis thresholds. At 614, the system can slice points satisfying one or more Z-axis thresholds. It is to be understood that the slicing is not limited to the axes or the coordinate spaces discussed herein. The method 600 then continues to 620.

At 620, the system generates a first ground plane corresponding to the environment. 620 can include at least one of 622 and 624. At 622, the system generates a first ground plane aligned to one or more points sliced by the frame thresholds. The system can generate the first ground plane based on the machine learning system of the plane generator 450, and can generate the first ground plane in accordance with the ground plane 330. The machine learning system can obtain one or more of the foreground points 320 and the object points 322, and can generate the first ground plane based on fitting at least a portion of the ground plane to at least a portion of the foreground points 320 and the object points 322. The first ground plane is not limited to an exact geometric plane, and can include variations, curvatures, and the like in accordance with a model corresponding to generating the first ground plane from the points. At 624, the system generates a first ground plane from the subset of the points detected from the environment and associated with a partial sweep. The method 600 then continues to 630.

At 630, the system generates one or more residual thresholds. 630 can include at least one of 632, 634 and 636. At 632, the system generates the residual thresholds based one a geometry of the sliced point cloud. The geometry of the sliced point cloud can include a geometric surface generated to fit at least a portion of the points of the sliced point cloud. The fit can correspond to points having a deviation from a mean or an ideal value corresponding to one or more points of the sliced point cloud. At 634, the system generates the residual thresholds based at least partially on the first ground plane. At 634, the system generates the residual thresholds based on the subset of the points detected from the environment and associated with a partial sweep. The method 600 then continues to 702.

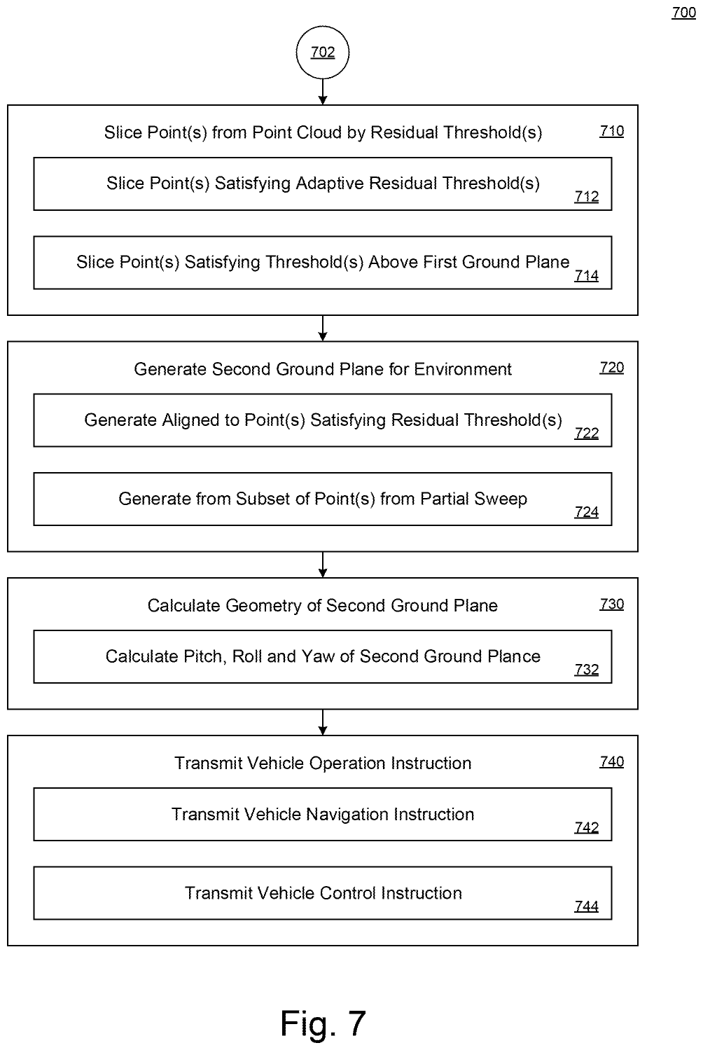

FIG. 7 illustrates an example method of real-time detection of and geometry generation for physical ground planes, further to the example method of FIG. 6. The system 100 can perform method 700 according to present implementations. The method 700 can begin at 702. The method 700 then continues to 710.

At 710, the system slices one or more points from the point cloud by the residual thresholds. 710 can include at least one of 712 and 714. At 712, the system slices the points satisfying one or more adaptive residual thresholds. The residual thresholds can be adaptive to the point clouds received, and can be adaptive over time based on the points of the point cloud received at any particular time or range of times. Thus, the residual thresholds can be variable with respect to the point cloud received, and can adapt to the geometry and the density, for example, of the point cloud. The adaptive thresholds can thus advantageously define a point cloud subspace smaller than the entire number of points received in the frame, and can generate the residual thresholds in real-time or substantially real-time to allow generation of ground planes faster than the rate of receipt of points to the point cloud across a frame capture time period. At 714, the system slices points satisfying one or more thresholds above a first ground plane. The method 700 then continues to 720.

At 720, the system generates a second ground plane corresponding to the environment. The system can generate the second ground plane based on the machine learning system of the plane generator 450, and can generate the second ground plane in accordance with the ground plane 340. The machine learning system can obtain one or more of the foreground points 320, and can generate the second ground plane based on fitting at least a portion of the ground plane to at least a portion of the foreground points 320. The second ground plane is not limited to an exact geometric plane, and can include variations, curvatures, and the like in accordance with a model corresponding to generating the first ground plane from the points. Thus, present implementations can advantageously generate at least one second plane, and potentially multiple planes, within the time required to capture a single frame including a complete point cloud. This increases the responsiveness of an at least partially autonomous vehicle navigation or control system without increasing cost or expense of requiring sensor input and scanning output hardware with a framerate faster than the plane generation rate. 720 can include at least one of 722 and 724. At 722, the system generates the second ground plane aligned to one or more points satisfying the residual thresholds. At 724, the system generates the second ground plane based on the subset of the points detected from the environment and associated with a partial sweep. The method 700 then continues to 730. At 730, the system calculates the geometry of the second ground plane. 730 can include 732. At 730, the system calculates at least one of the pitch, roll and yaw of the second ground plane. The method 700 then continues to 740.

At 740, the system transmits at least one vehicle operation instruction. The vehicle operation instructions can be based at least partially on a geometry of the second ground plane. 740 can include at least one of 742 and 744. At 742, the system transmits at least one vehicle navigation instruction. A vehicle navigation instruction can include at least one instruction to modify a path of the vehicle within the environment based on the ground plane. As one example, the vehicle navigation instruction can include an instruction to modify a heading of the vehicle. At 744, the system transmits at least one vehicle control instruction. The vehicle control instruction can include an environmental alarm including a proximity alarm, for example, and can include an instruction to modify a speed or heading of the vehicle, for example, in response to or in conjunction with the alarm instruction. In some implementations, the method 700 ends at 740.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A method of real-time detection of and geometry generation for physical ground planes, the method comprising:
generating a point cloud based on one or more detected points, the detected points being reflected from one or more projected points of focused light projected onto an environment;
slicing, in accordance with at least one coordinate space threshold, one or more threshold points from the point cloud to generate a first sliced point cloud excluding the threshold points;
slicing, in accordance with at least one residual threshold, one or more residual points from the first sliced point cloud to generate a second sliced point cloud excluding the residual points; and
generating a ground plane aligned with one or more points of the second point cloud in the coordinate space.

2. The method of claim 1, further comprising:
generating the residual threshold based on a geometry of the first sliced point cloud.

3. The method of claim 1, further comprising:
generating an intermediate ground plane aligned in the coordinate space with one or more points of the first sliced point cloud.

4. The method of claim 1, further comprising:
wherein the point cloud corresponds to a portion of a field of view of the environment.

5. The method of claim 4, further comprising:
capturing a frame comprising the point cloud, the frame corresponding to the field of view.

6. The method of claim 4, wherein the generating further comprises:
generating the ground plane based on a partial frame corresponding to the portion of the field of view.

7. The method of claim 1, further comprising:
detecting one or more of the projected points reflected from the environment,
wherein each of the detected points is associated with one or more corresponding spatial identifiers in the coordinate space.

8. The method of claim 7, wherein each of the projected points is associated with at least one of the corresponding spatial identifiers.

9. The method of claim 1, further comprising:
calculating a geometric characteristic of the second ground plane; and
transmitting a vehicle operation instruction based on the geometric characteristic.

10. A system comprising:
a point cloud generator configured to generate a point cloud based on one or more detected points, the detected points being reflected from one or more projected points of focused light projected onto an environment;
a point slicer engine configured to slice, in accordance with at least one coordinate space threshold, one or more threshold points from the point cloud to generate a first sliced point cloud excluding the threshold points, and slice, in accordance with at least one residual threshold, one or more residual points from the first sliced point cloud to generate a second sliced point cloud excluding the residual points; and
a plane generator configured to generate a ground plane aligned with one or more points of the second point cloud in the coordinate space.

11. The system of claim 10, the point slicer engine further configured to:
generate the residual threshold based on a geometry of the first sliced point cloud.

12. The system of claim 10, the plane generator further configured to:
generate an intermediate ground plane aligned in the coordinate space with one or more points of the first sliced point cloud.

13. The system of claim 10, wherein the point cloud corresponds to a portion of a field of view of the environment.

14. The system of claim 13, the point cloud generator configured to:
capture a frame comprising the point cloud, the frame corresponding to the field of view.

15. The system of claim 13, the plane generator further configured to:
generate the ground plane based on a partial frame corresponding to the portion of the field of view.

16. The system of claim 10, further comprising:
a point cloud generator configured to detect one or more of the projected points reflected from the environment,
wherein each of the detected points is associated with one or more corresponding spatial identifiers in the coordinate space.

17. The system of claim 16, wherein each of the projected points is associated with at least one of the corresponding spatial identifiers.

18. The system of claim 10, further comprising:
a vehicle operation interface configured to transmit a vehicle operation instruction based on a geometric characteristic of the second ground plane,
wherein the plane generator is further configured to calculate the geometric characteristic of the ground plane.

19. A computer readable medium including one or more instructions stored thereon and executable by a processor to:
generate a point cloud based on one or more detected points, the detected points being reflected from one or more projected points of focused light projected onto an environment;
slice, in accordance with at least one coordinate space threshold, one or more threshold points from the point cloud to generate a first sliced point cloud excluding the threshold points;
generate a residual threshold based on a geometry of the first sliced point cloud;
slice, in accordance with at least one residual threshold, one or more residual points from the first sliced point cloud to generate a second sliced point cloud excluding the residual points;
generate a ground plane aligned with one or more points of the second point cloud in the coordinate space; and
calculate a geometric characteristic of the second ground plane.

20. The computer readable medium of claim 19, wherein the computer readable medium further includes one or more instructions executable by a processor to:
detect one or more of the projected points reflected from the environment,
wherein each of the detected points is associated with one or more corresponding spatial identifiers in the coordinate space.
